(19) United States
(12) Patent Application Publication
(10) Pub. No.: US 2014/0373599 A1
(43) Pub. Date: Dec. 25, 2014

(54) DETECTION AND LOCKING TO THE ABSORPTION SPECTRA OF GASSES USING QUARTZ ENHANCED PHOTOACOUSTIC SPRECTROSCOPY

(71) Applicant: TEXAS INSTRUMENTS INCORPORATED, Dallas, TX (US)

(72) Inventors: Django TROMBLEY, Dallas, TX (US); Phillip Michel NADEAU, Cambridge, MA (US)

(21) Appl. No.: 13/926,516

(22) Filed: Jun. 25, 2013

(51) Int. Cl. G01N 29/24

(52) U.S. Cl. CPC G01N 29/2431
USPC 73/24.02

(57) ABSTRACT

A device for generating a frequency reference including a frequency reference generation unit coupled to an integration cell to generate a frequency reference signal based on radio frequency (RF) produced pressure waves detected by an acoustic detector in the integration cell.

### CROSS-REFERENCE TO RELATED APPLICATION

The present application may be related to co-pending U.S. patent application Ser. Nos. ______, ______, and ______.

### BACKGROUND

The many forms of spectroscopic analysis available may be used for various reasons, such as the frequencies involved or the material being measured. For each form of spectroscopy there may be multiple methods of implementation. For example, gas transmission spectroscopy may be performed using a light source or an x-ray source as the energy used to measure the spectrum of a gas. Another method to perform spectral gas analysis may involve quartz enhanced photoacoustic spectroscopy (QEPAS), which uses two mechanisms—optical excitation of the gas and measurement of the pressure wave created by the excited gas. The creation and detection of the pressure wave may coincide with characteristic absorption lines of the gas. QEPAS may be used to measure concentrations of a known gas sample or it may be used to determine the composition of an unknown gas sample.

### SUMMARY

A device for generating a frequency reference including a frequency reference generation unit coupled to an integration cell to generate a frequency reference signal based on radio frequency (RF) produced pressure waves detected by an acoustic detector in the integration cell.

A system for generating a frequency reference including an acoustic detector contained in an integration cell, the integration cell further containing a gas, a RF generation and modulation unit coupled to a RF transmitter to generate and modulate a RF signal, the RF transmitter to transmit the RF signal into the integration cell, and the RF signal causes a change of state in the gas that causes the acoustic detector to vibrate. The system further comprising a receiver coupled to the acoustic detector to detect a change the vibration of the acoustic detector.

A method for generating a frequency reference signal including transmitting a RF signal at an acoustic detector contained in an integration cell, the integration cell further containing a gas, detecting, by the acoustic detector, a pressure wave generated by an excitation of the gas due to absorption of the RF signal, and generating a frequency reference signal based on the frequency of the RF signal exciting the gas.

### BRIEF DESCRIPTION OF THE DRAWINGS

For a detailed description of exemplary embodiments of the invention, reference will now be made to the accompanying drawings in which:

FIG. 1 shows a block diagram of a frequency reference generator in accordance with various embodiments;

FIG. 2 shows a block diagram of another example of a frequency reference generator in accordance with various embodiments; and

FIG. 3 shows a flow chart of a method for generating a frequency reference signal in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Quartz enhanced photoacoustic spectroscopy (QEPAS) involves the use of optical energy to excite molecular absorption states in a material, a gas for example, to measure a transmission/absorption spectrum of the material. The molecular absorption states may correspond to absorption lines measured in the material's spectrum. The excited states may take various forms, rotation of the molecule around an axis or vibration of the atoms within the molecule, for example, and may be dependent upon the structure of the gas molecule. The excited state may also be energy dependent, which translates to a dependency upon the frequency or wavelength of the excitation energy. Optical excitation, for example, may coincide with a vibrational state of the gas molecule and occur at higher energies/frequencies. Rotational states may occur at lower energies/frequencies. The energy added to the gas molecules may then create a pressure wave within the gas due to the induced molecular vibrations. The pressure wave may then be detected by an acoustic detector such as a transducer, a tuning fork or a cantilever.

The optical energy may be generated by a laser or lasers and may be swept through a range of frequencies. By sweeping the excitation energy through a range of frequencies, spectral analysis may be performed on the material over that range. Any characteristic absorption lines of the gas in that range may be measured by the QEPAS method. QEPAS-based spectroscopy systems may either be passive (the acoustic detector may detect the pressure wave) or active (the acoustic detector is electrically stimulated by the system and a change in the frequency of vibration due to the pressure waves may be detected).

In addition to optical excitation, a modified QEPAS system may employ radio frequency (RF) signals to stimulate the excitation of gas molecules, for example. The modified-QEPAS system may implement many of the same detection schemes as with optical excitation. The RF-based QEPAS, due to the lower frequencies and energy of the excitation beam, may induce the rotational mechanisms in the gas instead of the vibrational mechanisms. One benefit to the rotational excitation is the strength of the induced pressure wave may be stronger than the pressure waves induced by optical excitation states. The stronger pressure wave, in turn, may then be more readily detected. Additionally, the use of RF lends itself well to implementation in multiple or single Silicon integrated circuit (IC) chips. The use of IC generated RF signals may allow an entire QEPAS-based spectrometer to be shrunk down to a single, printed circuit board-mountable device. In addition to performing spectral analysis, such a device may also be used to generate a frequency reference signal, much like a clock signal used in electronics that may be more accurate than a conventional crystal oscillator.

Disclosed herein are a system, device, and method to generate a frequency reference signal using a modified QEPAS technique. The modified QEPAS technique may use radio frequency (RF) energy to excite molecules of a gas at or around an absorption line of the gas. The excited gas may produce a pressure wave detectable by an acoustic detector, which in turn generates electrical signals at the resonating frequency of the acoustic detector. Those signals may then be analyzed to determine the frequency of the absorption line, which may then be used as a frequency reference signal.

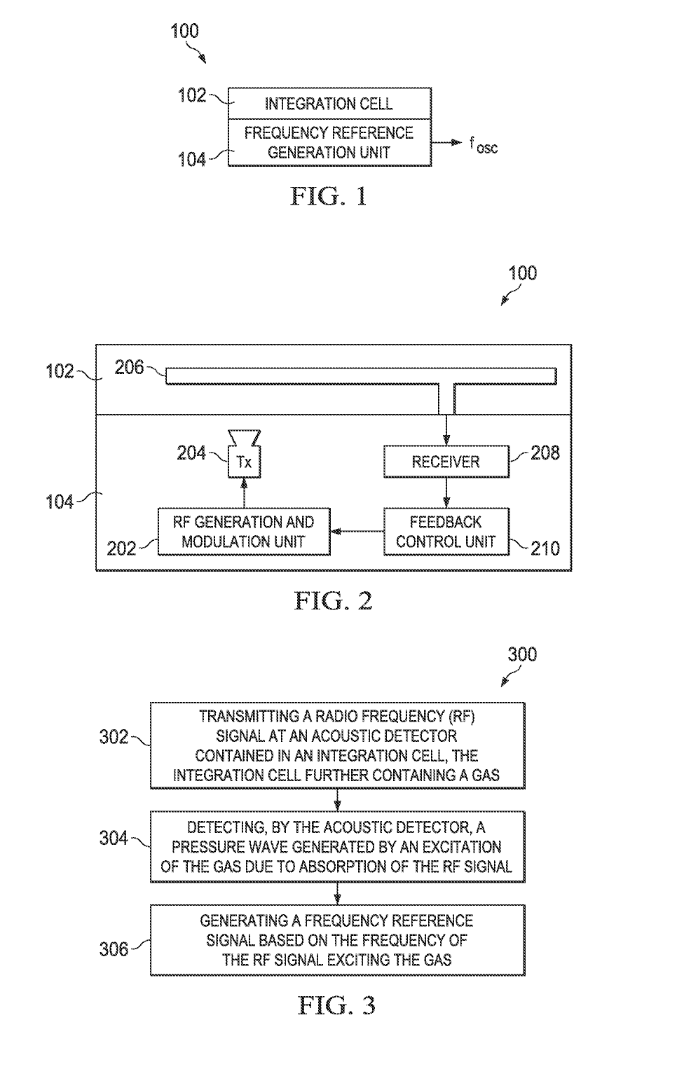

FIG. 1 shows a block diagram of a frequency reference generator 100 in accordance with various embodiments as discussed herein. The frequency reference generator 100 comprises an integration cell 102 and a frequency reference generation unit 104. The integration cell 102 may contain a gas and an acoustic detector. The acoustic detector may be a transducer, a cantilever or a tuning fork, for example, and may be coupled to the frequency reference generation unit 104. The gas may be any gas that displays a rotational vibration absorption mechanism in the millimeter, radar and terahertz (THz) range of the electromagnetic (EM) spectrum. The rotational absorption mechanism may correspond to an absorption line in a materials transmission spectrum. For example, water shows a strong absorption line at 183.31 GHz, which may correspond to a rotational excitation mechanism.

The frequency reference generation unit 104 may generate a frequency reference signal based on an absorption line of the gas contained in the integration cell 102. The generation of the frequency reference signal may include the frequency reference generation unit 104 generating and modulating RF signals that are transmitted into the integration cell 102. The frequency reference generation unit 104 may modulate the RF signals using frequency modulation (FM), frequency-shift keying (FSK) or a combination of the two. The RF signals may be swept through a range of frequencies to detect the absorption line of the gas. Once the absorption line of the gas has been detected, the frequency reference generation unit 104 may produce a feedback signal to control the frequency at which the RF signals are generated so to lock-in on and track the absorption line of the gas. The center frequency of the absorption line, which may be determined from the frequencies at which the RF signals are transmitted, may be used as a frequency reference signal, such as f_{osc}.

FIG. 2 shows a block diagram of another example of a frequency reference generator 100 in accordance with various embodiments as discussed herein. The frequency generator 100 comprises the integration cell 102 and the frequency reference generation unit 104. The integration cell 102 comprises acoustic detector 206 and a gas, such as water vapor. The acoustic detector 206 may be a transducer, a cantilever or a tuning fork, to list a few examples, and may be used to detect pressure changes in the integration cell 102 due to an excited state of the gas. The gas in the integration cell 102 may display characteristic absorption lines at various frequencies in the millimeter, radar, and THz frequencies of the EM spectrum. The absorption lines in these frequency ranges may correspond to rotational excitation states of the molecules in the gas.

The frequency reference generation unit 104 may further comprise a RF generation and modulation unit 202, a RF transmitter 204, a receiver 208, and a feedback control 210. The RF generation and modulation unit 202 may generate and modulate the RF signals transmitted into the integration cell 102 by the RF transmitter 204. The RF signals may be initially swept through a range of frequencies so the absorption line of the gas is detected. The absorption line may not always be at the same frequency due to environmental factors, i.e., temperature and pressure, of the integration cell 102. Thus, a range of frequencies around the absorption line of interest may first be swept through by the RF generation and modulation unit 202 to find the absorption line. To aid in the detection, and eventual tracking, of the absorption line of the gas, a modulation scheme such as FM or FSK may be employed when transmitting the RF signals. If FM is used, the RF signal may be swept through the range of frequencies around the absorption line but modulated with a frequency that may correspond to the resonant frequency of the acoustic detector.

If the FSK modulation scheme is used, then the RF generation and modulation unit 202 may generate two RF signals, or tones, separated by a fixed frequency range. The separation between the two tones may be such that the two tones intersect the absorption line of the gas at the half-width, half-maximum point of the absorption line. By separating the two tones accordingly, the two tones may intersect the absorption line at a point of maximum slope. Using the point of maximum slope may give the frequency reference generation unit 104 the most robust control for locking-in on and tracking the absorption line of the gas. The two tones may be alternately transmitted at a 50% duty cycle.

As discussed above, the RF energy may be absorbed by the gas. The gas molecules may then begin to experience a rotational vibration. The induced rotational vibrations may then produce pressure waves in the gas, which may be detected by the acoustic detector 206, such as a cantilever or a tuning fork. Since the absorption line of the gas has some width greater than a singular function, the intensity of the pressure waves may vary as the frequency of the RF signals move across the frequencies of the absorption line. The pressure wave intensities may be at a maximum at the center frequency of the absorption line.

If the pressure waves are produced at a frequency that corresponds to the resonant frequency of the acoustic detector 206, then the acoustic detector 206 may begin vibrating at that frequency. Due to the piezoelectric effect, the acoustic detector 206 may then generate electrical pulses due to the induced vibrations. Further, the acoustic detector 206 may be coupled to the receiver 208.

The RF transmitter 204 and the acoustic detector 206 may be in close proximity to one another. Additionally, the RF transmitter 204 may not include a designed antenna. As such, the RF signals may radiate from the inherent dipole associated with the RF transmitter 204. Without the use of a designed antenna, the RF signals may propagate out from the RF transmitter 204 in a single lobe pattern originating and concentrated at the dipole. By placing the acoustic detector 206 in close proximity to the dipole, the RF transmitter 204 will appear as a point source to the acoustic detector 206, which may negate the need for RF beam shaping and steering. Alternatively, a designed antenna may be included with the RF transmitter 204 to shape and steer the RF beam toward the acoustic detector 206. Shaping and steering the RF beam may be implemented if the RF transmitter 204 and the acoustic detector 206 are not in close proximity to one another. The separation distance between the RF transmitter and the acoustic detector 206 may be enough to allow the acoustic detector 206 to move and vibrate without coming into contact with the RF transmitter 204. Additionally, the separation distance may be frequency dependent, which may relate to the amount of displacement the acoustic detector 206 moves.

The receiver 208 may analyze the signals received from the acoustic detector 206 to determine when the absorption line of the gas has been detected. Since the acoustic detector 206 may only generate a signal when the gas is absorbing the RF energy, meaning the frequencies the RF signals are being transmitted are being absorbed by the gas, the analyzer will need to determine when the center frequency of the absorption line has been detected. When using FM modulation the receiver 208 may analyze the received signals using a peak detection method. The peak detection method may analyze the strength of the received signals as the RF excitation energy passes through the center frequency of the absorption line. The center frequency corresponding to the maximum absorption may produce the strongest response in the acoustic detector 206. As the RF excitation energy moves past the center frequency of the absorption line, the strength of the received signals may decrease. The received signal strengths at the various RF excitation energies around the center frequency of the absorption line may then be used to determine the frequency at which the center frequency of the absorption line occurs. The various signals strengths associated with different excitation energies may also be used as feedback.

When using FSK modulation the receiver 208 may compare the strengths of the received signals associated with the two tones to one another. When the received signal strengths of the two tones are equal, the two tones may be straddling the center frequency of the absorption line so that the mid-point frequency between the two tones corresponds with the center frequency of the absorption line. When this condition is met, the absorption line has likely been detected. The relative differences between the strength of the received signals associated with the two tones may also be used by the feedback control unit 210 to drive the RF generation and modulation unit 202.

The feedback control unit 210 may be coupled to the receiver 208 and may generate a feedback control signal that drives the frequencies at which the RF generation and modulation unit 202 are generating and transmitting. For FM modulation, the feedback control unit 210 may use the signal strengths at the frequencies around the center frequency of the absorption line to adjust the frequency or frequencies at which the RF excitation energy is being transmitted into the integration cell 102. As the received signal strengths fluctuate, the differences between the signals may generate the control signal used to drive the RF generation and modulation unit 202.

The feedback control unit 210, when FSK modulation is used, may use the relative differences in strength of the received signals corresponding to the two tones to generate a control signal. The difference of the received signal strength associated with the two tones may generate a control signal that determines how much the frequencies of the two tones should be adjusted and in what direction (higher or lower frequencies). For example, if tone 2 is at a higher frequency than tone 1, then the control signal may be the received signal strength associated with tone 2 minus the received signal strength associated with tone 1. When the signal associated with tone 1 is stronger than the signal associated with tone 2 the difference may be negative implying that the frequencies should be adjusted lower. When tone 2 is stronger than tone 1, then the opposite may occur.

Once the center frequency has been detected and locked onto, then the frequency reference generator 100 may output a frequency reference signal at a frequency equal to that of the center frequency of the absorption line. Further, due to the feedback control unit 210, the frequency reference signal may be constant. By using RF frequencies in the millimeter, radar, and terahertz regions of the EM spectrum, the various components of the frequency reference generation unit 104 may be manufactured on Silicon in one or more integrated circuits (IC's). The integration cell 102 may be constructed so that it may be mounted to the IC or ICs that form the frequency reference generation unit 104 forming a printed circuit board (PCB) mountable device.

FIG. 3 shows a flow chart of a method 300 for generating a frequency reference signal in accordance with various embodiments as discussed herein. The method 300 may be implemented by the device and system discussed above to generate a frequency reference signal, such as f_{osc} of FIG. 1. The method 300 begins at step 302 with transmitting a RF signal at an acoustic detector contained in an integration cell, the integration cell further containing a gas. The RF signal may be generated and modulated by the RF generation and modulation unit 202 before being transmitted into the integration cell 102 by the RF transmitter 204. Additionally or alternatively, the RF signal may be swept through a range of frequencies, where an absorption line of the gas contained in the integration cell 102 may be encountered.

The method 300 continues at step 304 with detecting, by the acoustic detector, a pressure wave generated by an excitation of the gas due to absorption of the RF signal. The pressure wave may be created due to the molecules of the gas absorbing the energy of the RF signal. The absorption of the energy by the gas may cause the gas to vibrate in a rotational manner. Meaning, the absorption line of the gas may coincide with an excitation mechanism associated with the gas, namely a rotational excitation, which will induce a rotation in the absorbing molecules of the gas. The rotating molecules may then generate a pressure wave, which may be detected by the acoustic detector, such as a cantilever or a tuning fork. The pressure waves may cause the acoustic detector to vibrate at its resonant frequency. The acoustic detector may generate an electrical pulse or signal due to its vibration.

The method 300 ends at step 306 with generating a frequency reference signal based on the frequency of the RF signal exciting the gas. The pressure waves detected by the acoustic detector 206 may be analyzed to determine when the center frequency of the gas absorption line has been detected. Once the center frequency has been detected, the frequency reference generator 100 may use the center frequency of the absorption line as a frequency reference.

The frequency reference generator 100 may also be used for spectral analysis of known and unknown gas samples. By incorporating a mechanism for removing and importing gas samples into the integration cell 102, the frequency reference generator 102 may be used to analyze various gas samples and produce a transmission spectrum for the ranges of frequencies discussed above. The same method 300 may be implemented to determine absorption lines and concentrations of gases in measured samples.

Additionally, the frequency reference generator may also be used as a temperature and pressure sensor by measuring the movement of the center frequency of the absorption line. The change in frequency of the absorption line may be correlated to different combinations of pressure and temperature.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A device for generating a frequency reference, comprising:
a frequency reference generation unit coupled to an integration cell to generate a frequency reference signal based on radio frequency (RF) produced pressure waves detected by an acoustic detector in the integration cell.

2. The device of claim 1, wherein the integration cell contains a gas.

3. The device of claim 1, wherein the frequency reference generation unit further comprises a RF generation and modulation component coupled to a RF transmitter.

4. The device of claim 3, wherein the RF signal is modulated with a frequency-shift keying scheme.

5. The device of claim 1, wherein the acoustic detector generates electrical signals corresponding to the detected pressure waves.

6. The device of claim 1, wherein the frequency reference generation unit further comprises a receiver to analyze the frequency at which the pressure waves are detected.

7. The device of claim 1, wherein the frequency reference generation unit further comprises a feedback module to adjust the frequency at which the RF signal is generated based on the frequency at which the pressure waves are detected.

8. The device of claim 1, wherein the acoustic detector is a cantilever.

9. The device of claim 1, wherein the acoustic detector is a tuning fork.

10. A system for generating a frequency reference, comprising:
an acoustic detector contained in an integration cell, the integration cell further containing a gas;
a radio frequency (RF) generation and modulation unit coupled to a RF transmitter to generate and modulate a RF signal;
the RF transmitter to transmit the RF signal into the integration cell, wherein the RF signal causes a change of state in the gas that causes the acoustic detector to vibrate; and
a receiver coupled to the acoustic detector to detect a change the vibration of the acoustic detector.

11. The system of claim 10, further comprising a feedback module to adjust the frequency at which the RF signal is transmitted based on a detected change of the frequency of vibration of the acoustic detector.

12. The system of claim 10, wherein the RF generation and modulation unit modulates the RF signal with a frequency modulation scheme.

13. The system of claim 10, wherein the RF generation and modulation unit modulates the RF signal with a frequency-shift keying scheme.

14. The system of claim 10, wherein the gas contained in the integration cell is water vapor.

15. The system of claim 10, wherein the acoustic detector is a transducer.

16. The system of claim 10, wherein the acoustic detector is a cantilever.

17. A method for generating a frequency reference signal, comprising:
transmitting a radio frequency (RF) signal at an acoustic detector contained in an integration cell, the integration cell further containing a gas;
detecting, by the acoustic detector, a pressure wave generated by an excitation of the gas due to absorption of the RF signal; and
generating a frequency reference signal based on the frequency of the RF signal exciting the gas.

18. The method of claim 17, further comprising adjusting the frequency at which the RF signal is transmitted based on feedback of the frequency of the RF signal exciting the gas.

19. The method of claim 17, further comprising sweeping the RF signal through a range of frequencies to locate the frequency at which the excitation of the gas occurs.

20. The method of claim 17, further comprising modulating the RF signal with a frequency-shift keying scheme.
